(19) United States
(12) Patent Application Publication
(10) Pub. No.: US 2015/0121314 A1
(43) Pub. Date: Apr. 30, 2015

(54) TWO-FINGER GESTURES

(71) Applicant: JENS BOMBOLOWSKY, Schwetzingen (DE)

(72) Inventor: JENS BOMBOLOWSKY, Schwetzingen (DE)

(21) Appl. No.: 14/062,828

(22) Filed: Oct. 24, 2013

(51) Int. Cl. G06F 3/0488

(52) U.S. Cl. CPC G06F 3/04883
USPC 715/863

(57) ABSTRACT

Methods and apparatus, including computer program products, are provided for two-finger gestures. In one aspect there is provided a method, which may include detecting a single-finger gesture proximate to a user interface; tracking the detected single-finger gesture to determine whether the detected single-finger gesture corresponds to a substantially circular motion; providing a first indication for presentation on the user interface, the first indication indicating at least a first selection on the user interface, when the detected single-finger gesture represents the substantially circular motion; detecting a two-finger gesture proximate to the user interface; tracking the detected two-finger gesture to determine whether the detected two-finger gesture corresponds to the substantially circular motion; and providing a second indication for presentation on the user interface, the second indication indicating at least a second selection on the user interface, when the detected two-finger gesture represents the substantially circular motion.

### FIELD

The present disclosure generally relates to gestures.

### BACKGROUND

Touch-based devices have become increasingly important for computer-based devices. For example, smart phones, tablets, and other devices include touch sensitive user interfaces to allow a user to make selections. Although touch-based devices may allow a user to touch a user interface to interact with the device, gestures used to interact with the device may not be intuitive or may be difficult for some users to gesture, making it more difficult for the users to interact with the device via touch.

### SUMMARY

Methods and apparatus, including computer program products, are provided for two-finger gestures. In one aspect there is provided a method, which may include detecting a single-finger gesture proximate to a user interface; tracking the detected single-finger gesture to determine whether the detected single-finger gesture corresponds to a substantially circular motion; providing a first indication for presentation on the user interface, the first indication indicating at least a first selection on the user interface, when the detected single-finger gesture represents the substantially circular motion; detecting a two-finger gesture proximate to the user interface; tracking the detected two-finger gesture to determine whether the detected two-finger gesture corresponds to the substantially circular motion; and providing a second indication for presentation on the user interface, the second indication indicating at least a second selection on the user interface, when the detected two-finger gesture represents the substantially circular motion.

In some implementations, the above-noted aspects may further include additional features described herein including one or more of the following. The user interface may include a first ring including a first set of items, wherein the first selection selects at least one of the first set of items. The user interface may include a second ring including a second set of items, wherein the second selection selects at least one of the second set of items. The first set of data items and the second set of data items may include interrelated data. The interrelated data may include time information and/or calendar information. Tracking may include determining when the detected two-finger gesture represents a predetermined increment of rotation. Based on the predetermined increment of rotation, an update to the user interface may be provided.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIGS. 1 and 2 depict examples of user interfaces including touch wheels selectable using two-finger gestures;

FIGS. 3A-3B depict example gestures which can be used on the user interface including the touch wheel;

FIG. 4A depicts an example of a system for detecting a two-finger gesture;

FIG. 4B depicts an example of a processor for detecting a two-finger gesture; and

FIGS. 5-7 depict additional examples of user interfaces including touch wheels selectable using two-finger gestures;

Like labels are used to refer to same or similar items in the drawings.

### DETAILED DESCRIPTION

Some touch-based devices allow a user to make item selections via a wheel. For example, a touch sensitive area, such as a touch wheel, may be touched, allowing a user to make a selection. For example, by touching the touch wheel and then gesturing with a finger motion on the touch wheel with a generally circular motion along the wheel, a user may select an item being presented on a user interface.

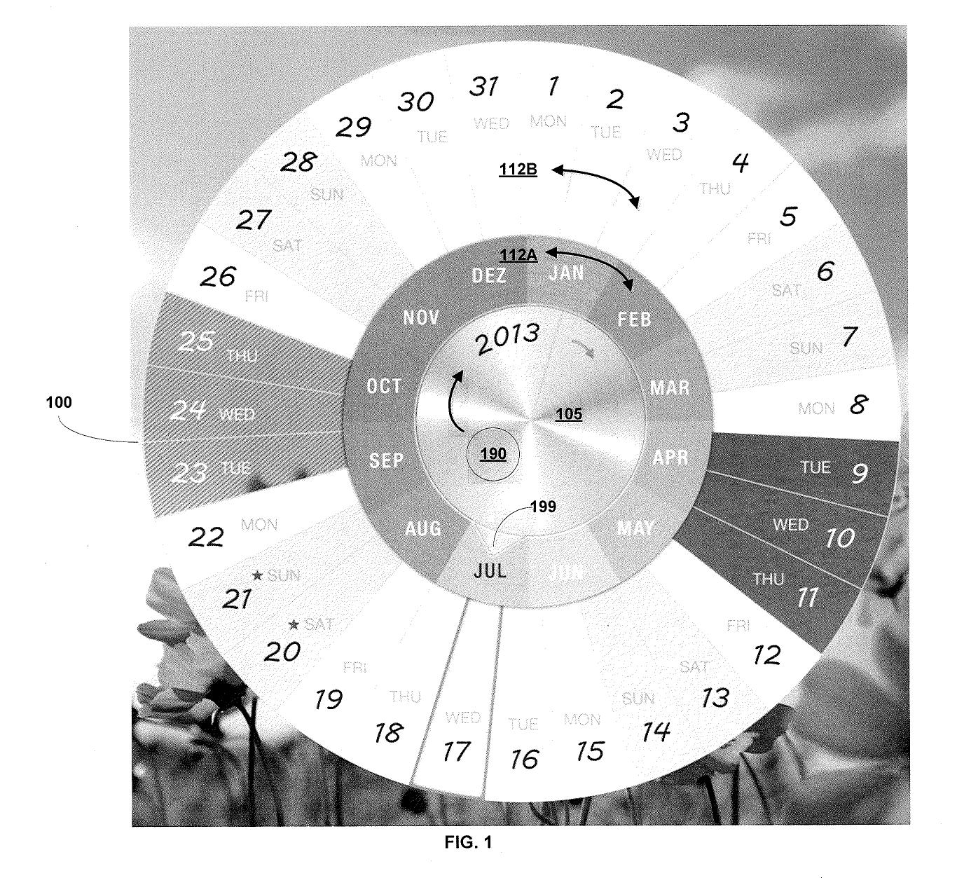

FIG. 1 depicts a touch wheel 105 and an image including a first set of items presented on an inner ring 112A and a second set of items presented on an outer ring 112B. In the example of FIG. 1, the first ring 112A includes items, such as months of the year (for example, January through December), and the second ring 112B includes items, such as days of the month selected on the first ring 112B.

In the example of FIG. 1, a single finger 190 may tap touch wheel 105 and then finger 190 may make a generally circular finger motion in a clockwise (or counterclockwise) rotational motion. While the finger gestures in this motion, a user interface 100 indicates a selection of an item presented on the first ring 112A. For example, a generally circular finger motion in a clockwise (or counterclockwise) rotational motion on the touch wheel may be used to select a month, such as the month of July (JUL), which is graphically highlighted or otherwise distinguished (see, for example, arrow 199) graphically to show selection. Thus, a first finger gestures using a generally circular motion on the touch wheel 105 may be used to select a first item, such as month, from among a plurality of items listed on inner ring 112A providing a generally circular presentation pattern for the set of items, such as months.

However, to select a second item on the second, outer ring 112B, the subject matter disclosed herein provides a two-finger gesture.

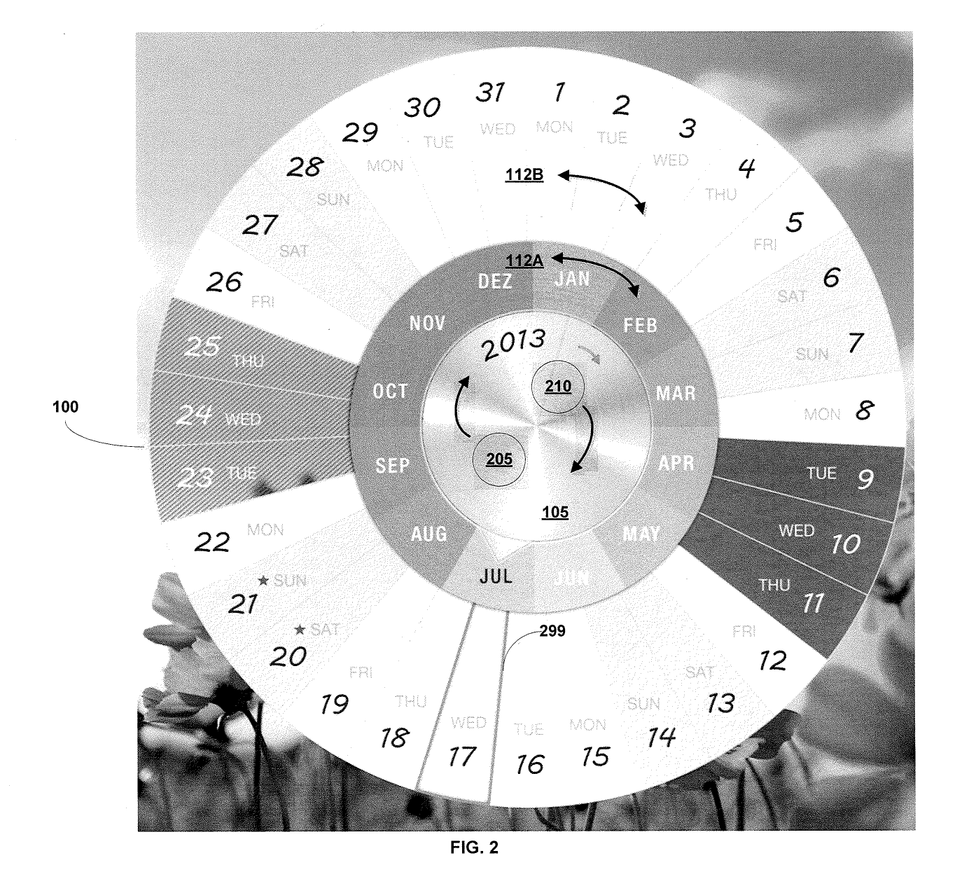

FIG. 2 depicts user interface 100 of FIG. 1, but after the single finger gesture has selected the month, July, as noted above with respect to FIG. 1. In some example implementations, a two-finger gesture 205 and 210 may tap touch wheel 105 and then the two-fingers 205 and 210 may make a generally circular finger motion in a clockwise (or counterclockwise) rotational motion. While the two fingers 205/210 gesture in this generally circular motion, user interface 100 indicates a selection of an item presented on the second, outer ring 112B. For example, a generally circular two-finger motion in a clockwise (or counterclockwise) rotational motion on the touch wheel 105 may be used to select on the outer ring 112B a day, such as the 17^{th} (which is graphically highlighted or otherwise distinguished graphically to show selection). Thus, the two-finger gesture 205/210 using a generally circular motion on the touch wheel may be used to select an item, such as a day from a selected month, from among a plurality of items listed on outer ring 112B. The selection on the outer ring 112B may be graphically highlighted 299 or otherwise distinguished graphically to show selection.

Although the previous example describes selecting a month and a day, other items may be selected as well.

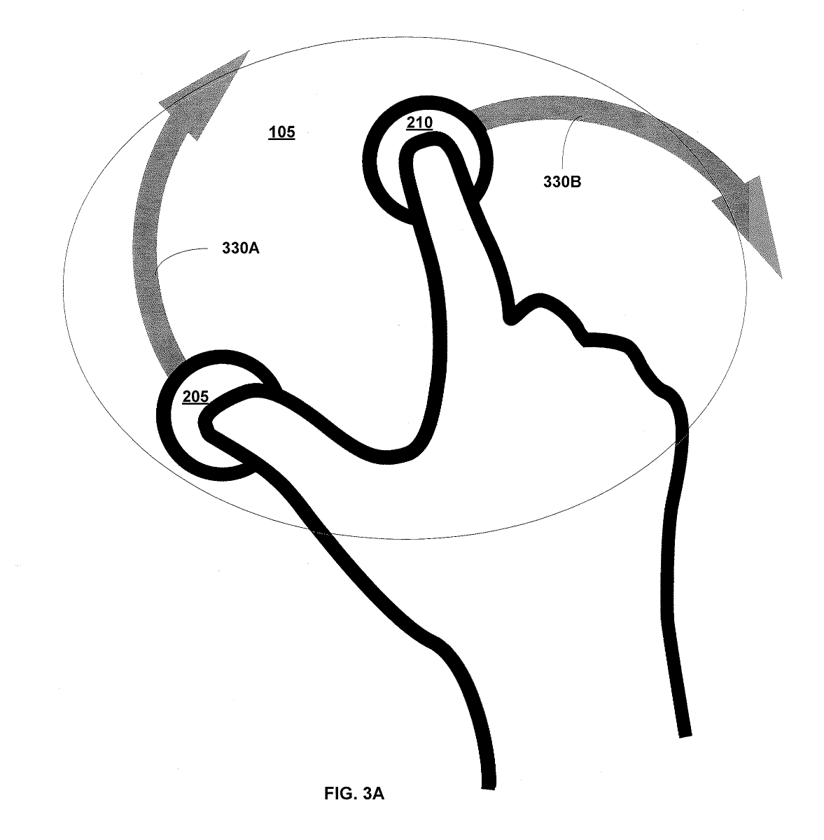

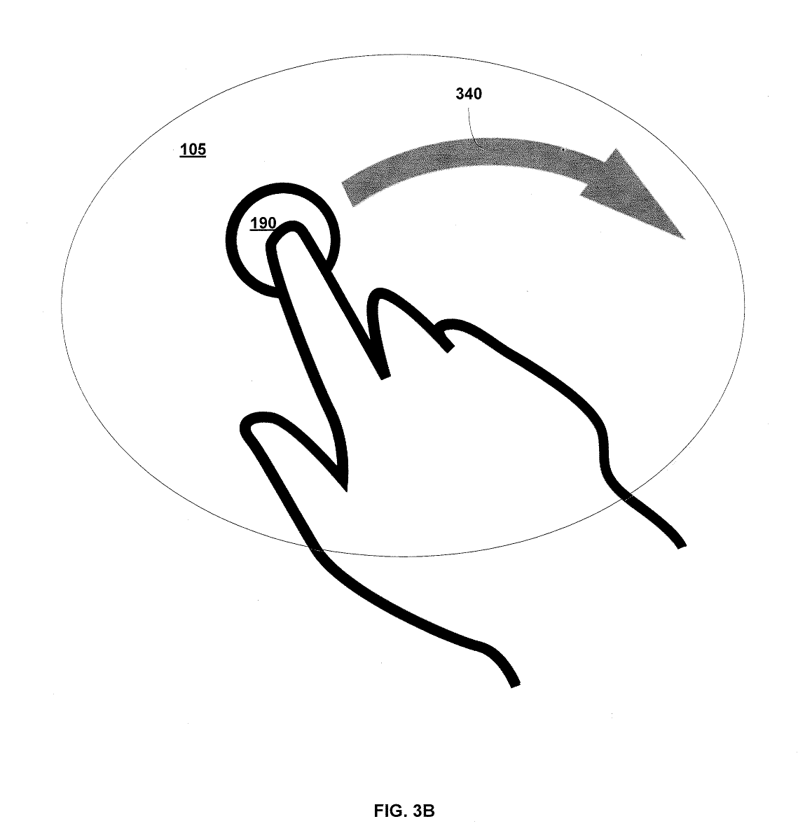

FIG. 3A depicts an example of the two-finger gesture 205 and 210 with the corresponding circular gesture 330A-B, which may be performed on the touch wheel 105, while FIG. 3B depicts the corresponding single-finger gesture 340. The circular gesture may be considered circular in the sense that motion 330A may extend about a radius and motion 330B may also extend about a radius. In addition, the radius may vary during the gestures. Moreover, the circular gesture may be somewhat elliptical and/or curved as well. In addition, the two fingers may move jointly, so that both fingers gesture in the same or similar elliptical and/or curved gesture. Although some of the examples disclosed herein refer to somewhat elliptical and/or curved gestures, the joint finger motion may have other shapes as well including substantially a square, substantially a rectangle, substantially a triangle, and/or any other shape.

In some example implementations, the amount of circular rotation represents a certain change in selection on the inner ring 112A or outer ring 112B. For example, suppose the user interface 100 indicates a day value of the 17^{th}. In this example, a 90-degree clockwise rotation of two fingers 205/210 may cause the user interface 100 to present an image indicating a selection incremented by a predetermined amount, such as one day (for example, to the 18^{th}, while a 90-degree counter clockwise rotation of two fingers 205/210 may cause the user interface to present an image indicating a selection decremented by a predetermined amount, such as moving back by a day to the 16^{th}.

Although the previous example provided an example where a 90-degree two-finger rotation causes movement by one day, other amounts of rotation, increments, and/or decrements along the outer (or inner) ring may be implemented as well. For example, a 180-degree clockwise rotation of the two-finger gesture 205/210 may cause the selection to increase by a seven days (a week). Moreover, the amount of increment and associated rotation may be selected by a user and/or pre-programmed.

In some example implementations, a user may thus make two different types of selections within the same touch area, such as touch wheel 105, by using two different, rotating finger gestures, such as a single finger gesture assigned to a first set of items presented on a first ring and a two-finger gesture assigned to a second set of items presented on an outer ring.

In some example implementations, touch wheel 105 may be implemented as a mechanical switch configured to detect the movement of the finger or fingers. The touch wheel may also be implemented as a capacitive-sensitive touch area also capable of detecting finger(s) and their gestures as disclosed herein. The touch wheel 105 may also be implemented virtually, as an image presented within a user interface. For example, a touch sensitive display may present the touch wheel 105 and detect the gestures as disclosed herein. In some example embodiments, the user interface 100 may comprise a touch sensitive display presenting the outer ring 112B and the inner ring 112A, as well as the touch wheel 105. Alternatively or additionally, a touch pad may be used as the touch sensitive area where the finger gestures disclosed herein may be applied. Moreover, the touch wheel may be implemented in forms other than a wheel as well (for example, having other shapes and the like). In the case of a touchpad, the user interface touch areas may be used to provide instructions, hints, and the like regarding use of the touch pad.

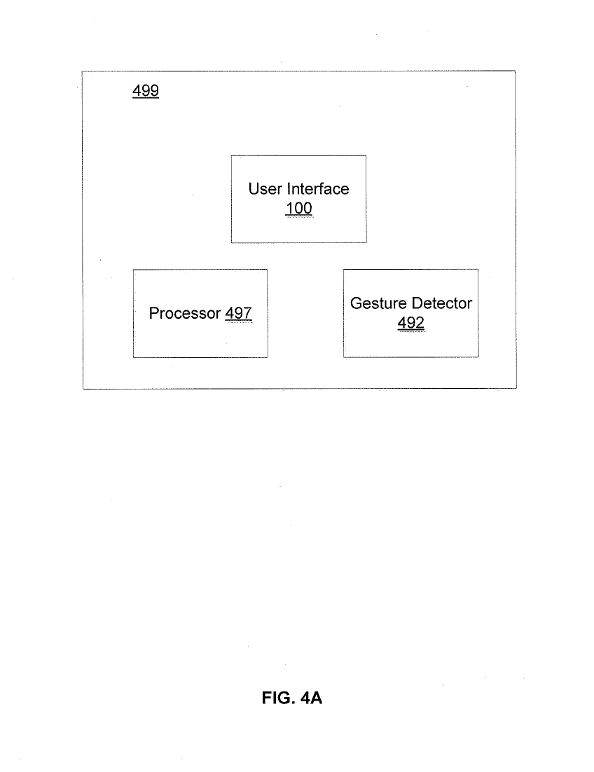

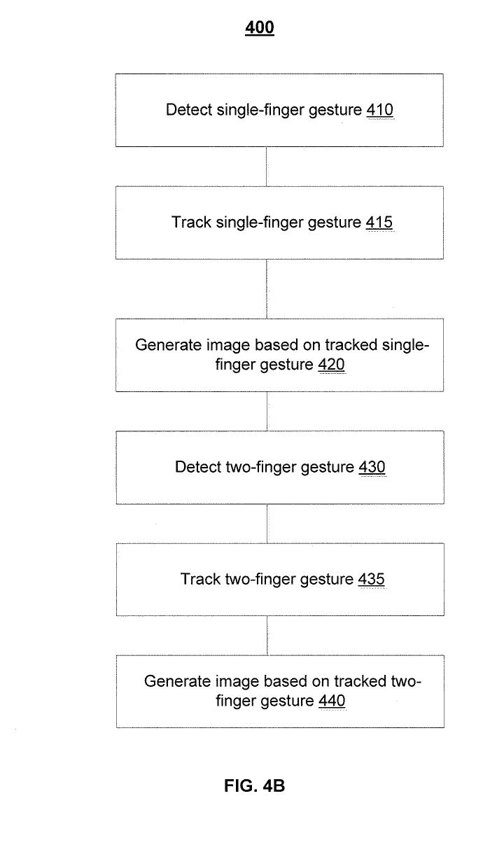

FIG. 4A depicts a system 499 for gesturing, in accordance with some example implementations. The description of FIG. 4A also refers to FIG. 2.

System 499 may include a user interface 100, a processor 497, and a gesture detector 492. The user interface 100 may include a touch area, such as touch wheel 105 and items for selection by the touch wheel (which may be arranged in rings 112A-B, although other forms may be used as well). The processor 497 may comprise at least one processor circuitry and at least one memory including computer code, which when executed may provide one or more of the functions disclosed herein. For example, the gesture detector 492 may be implemented using processor 497, although gesture detector 492 may be implemented using dedicated circuitry as well. To illustrate further, user interface 100 may include a touch sensitive user interface, such as a display, and some of the aspects of the gesture detector 492 may be incorporated into the user interface 100.

FIG. 4B depicts a process 400 for gesturing, in accordance with some example implementations. The description of FIG. 4B also refers to FIGS. 1, 2, 3A, 3B and 4A.

At 410, a single-finger gesture may be detected. For example, when a user touches (or is proximate to) touch wheel 105, the gesture detector 492 may detect this event, and track, at 425, the event to determine whether the gesture is a single-finger rotational (for example, circular) gesture. In some example implementations, gesture detector 492 may have a pattern of the single-finger rotational gesture. And, if the tracked single-finger motion matches the pattern (or a variant thereof), the gesture detector 492 may determine that the motion is indeed a single, finger circular gesture.

At 420, an image may be generated to indicate the tracked single-finger gesture. For example, processor 497 may, while the gesture detector 492 tracks the single-finger gesture, update the user interface 100 to show the movement of the single-finger and/or selection. To illustrate further, as the finger rotates clockwise around touch wheel 105 (FIG. 1), the user interface 100 may graphically show the months being selected change (for example, via a change in a graphical indication, such as bolding, highlighting, a pointer 199) until the finger gesture stops, which in the example of FIG. 1 corresponds to the month of July (JUL).

At 430, a two-finger gesture may be detected. For example, when a user touches (or is proximate to) touch wheel 105, the gesture detector 492 may detect this event, and track, at 435 the event to determine whether the gesture is a two-finger rotational or circular gesture. In some example implementations, gesture detector 492 may have a pattern of the two-finger rotational gesture and if the tracked two-finger motion matches the pattern (or a variant thereof), the gesture detector 492 may determine that the motion is indeed a two, finger circular gesture.

At 440, an image may be generated to indicate the tracked two-finger gesture. Processor 497 may, while the gesture detector 492 tracks the two-finger gesture, update the user interface 100 to show the movement of the two-finger and/or selection. As the finger rotates clockwise around touch wheel 105 (FIG. 2), user interface 100 may graphically show the days being selected change (for example, via a change in a graphical indication, such as bolding, highlighting, and the like) until the two finger gesture stops, which in the example of FIG. 2 corresponds to day of the 17^{th}.

Although the previous example describes a specific use case, other uses cases may be implemented as well.

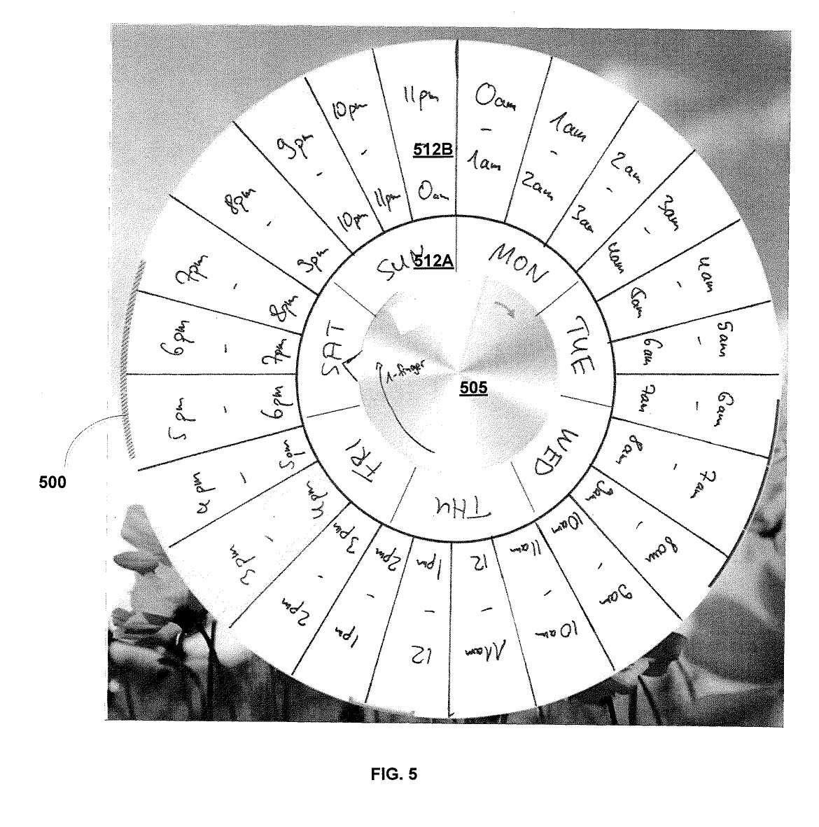

FIG. 5 depicts another example user interface 500. The user interface may include an inner ring 512A, an outer ring 512B, and a touch wheel 505. In the example of FIG. 5, the inner ring 512A may include items, such as days of week selectable with the single finger rotational touch gesture described above with respect to for example 410. The outer ring 512B may include time of day selectable with the two-finger rotational touch gesture described above with respect to for example 430.

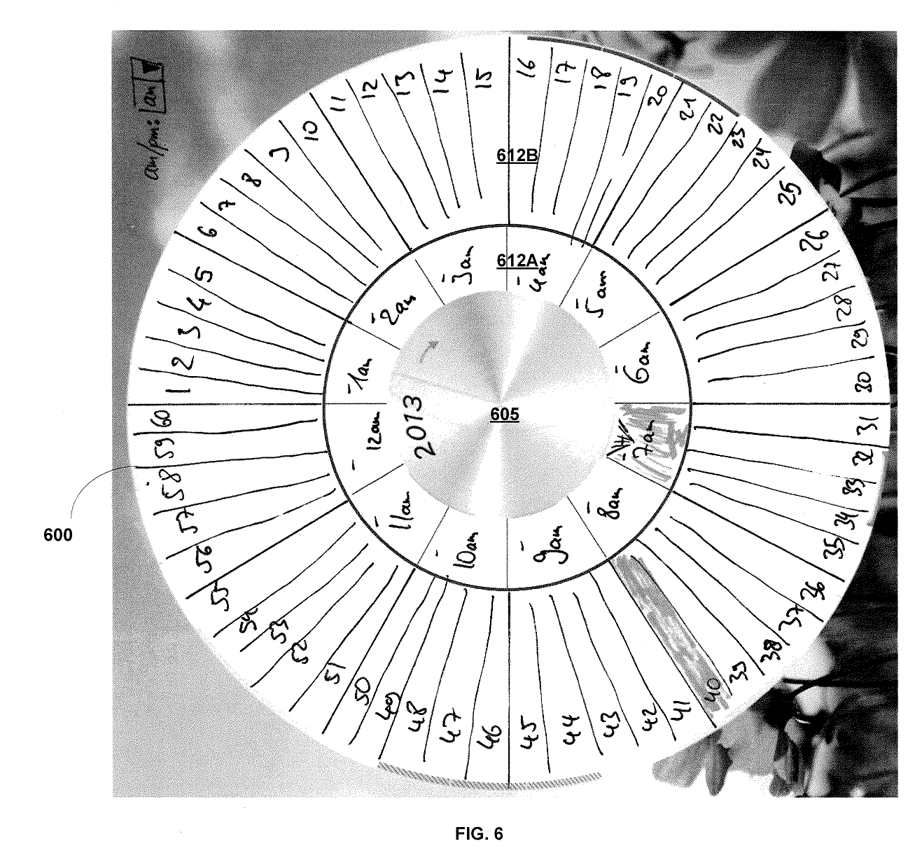

FIG. 6 depicts another example user interface 600. The user interface may include an inner ring 612A, an outer ring 612B, and a touch wheel 605. In the example of FIG. 6, the inner ring 612A may include item, such as hours selectable with the single finger rotational touch gesture described above with respect to for example 410. The outer ring 612B may include minutes, which can be selected with the two-finger rotational touch gesture described above with respect to for example 430.

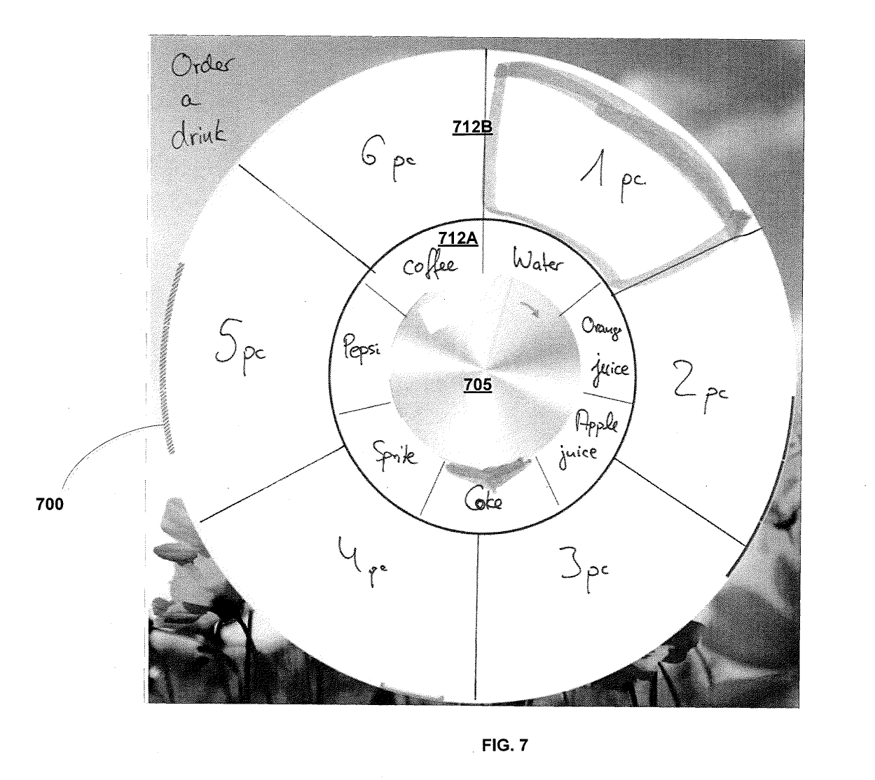

FIG. 7 depicts another example user interface 700. The user interface may include an inner ring 712A, an outer ring 712B, and a touch wheel 705. In the example of FIG. 7, the inner ring 712A may include items, such as types of beverages which can be selected with the single finger rotational touch gesture described above with respect to for example 410. The outer ring 712B may include a quantity (for example, how many, portion size, and the like) which can be selected with the two-finger rotational touch gesture described above with respect to for example 430.

Although some of the examples disclosed herein include items on the inner ring that are directly related to the items on the outer ring (for example, the day of the week presented on the outer ring may depend on a given month selected on the inner ring), the items on each ring may be independent as well.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A non-transitory computer-readable medium containing instructions to configure at least one processor to cause operations comprising:
detecting a single-finger gesture proximate to a user interface;
tracking the detected single-finger gesture to determine whether the detected single-finger gesture corresponds to a substantially circular motion;
providing a first indication for presentation on the user interface, the first indication indicating at least a first selection on the user interface, when the detected single-finger gesture represents the substantially circular motion;
detecting a two-finger gesture proximate to the user interface;
tracking the detected two-finger gesture to determine whether the detected two-finger gesture corresponds to the substantially circular motion; and
providing a second indication for presentation on the user interface, the second indication indicating at least a second selection on the user interface, when the detected two-finger gesture represents the substantially circular motion.

2. The non-transitory computer-readable medium of claim 1, wherein the user interface includes a first ring including a first set of items, wherein the first selection selects at least one of the first set of items.

3. The non-transitory computer-readable medium of claim 2, wherein the user interface includes a second ring including a second set of items, wherein the second selection selects at least one of the second set of items.

4. The non-transitory computer-readable medium of claim 3, wherein the first set of data items and the second set of data items comprise interrelated data.

5. The non-transitory computer-readable medium of claim 3, wherein the interrelated data comprises at least one of time information and calendar information.

6. The non-transitory computer-readable medium of claim 1, wherein the tracking of the detected two-finger gesture further comprises:
determining when the detected two-finger gesture represents a predetermined increment of rotation.

7. The non-transitory computer-readable medium of claim 6 further comprising:
providing an updated to the user interface based on the predetermined increment of rotation.

8. A system comprising:
at least one processor; and
at least one memory including computer program code which when executed by the at least one processor causes operations comprising:
detecting a single-finger gesture proximate to a user interface;
tracking the detected single-finger gesture to determine whether the detected single-finger gesture corresponds to a substantially circular motion;
providing a first indication for presentation on the user interface, the first indication indicating at least a first selection on the user interface, when the detected single-finger gesture represents the substantially circular motion;
detecting a two-finger gesture proximate to the user interface;
tracking the detected two-finger gesture to determine whether the detected two-finger gesture corresponds to the substantially circular motion; and
providing a second indication for presentation on the user interface, the second indication indicating at least a second selection on the user interface, when the detected two-finger gesture represents the substantially circular motion.

9. The system of claim 8, wherein the user interface includes a first ring including a first set of items, wherein the first selection selects at least one of the first set of items.

10. The system of claim 9, wherein the user interface includes a second ring including a second set of items, wherein the second selection selects at least one of the second set of items.

11. The system of claim 10, wherein the first set of data items and the second set of data items comprise interrelated data.

12. The system of claim 11, wherein the interrelated data comprises at least one of time information and calendar information.

13. The system of claim 8, wherein the tracking of the detected two-finger gesture further comprises:
determining when the detected two-finger gesture represents a predetermined increment of rotation.

14. The system of claim 13 further comprising:
providing an updated to the user interface based on the predetermined increment of rotation.

15. A method comprising:
detecting a single-finger gesture proximate to a user interface;
tracking the detected single-finger gesture to determine whether the detected single-finger gesture corresponds to a substantially circular motion;
providing a first indication for presentation on the user interface, the first indication indicating at least a first selection on the user interface, when the detected single-finger gesture represents the substantially circular motion;
detecting a two-finger gesture proximate to the user interface;
tracking the detected two-finger gesture to determine whether the detected two-finger gesture corresponds to the substantially circular motion; and
providing a second indication for presentation on the user interface, the second indication indicating at least a second selection on the user interface, when the detected two-finger gesture represents the substantially circular motion.

16. The method of claim 15, wherein the user interface includes a first ring including a first set of items, wherein the first selection selects at least one of the first set of items.

17. The method of claim 16, wherein the user interface includes a second ring including a second set of items, wherein the second selection selects at least one of the second set of items.

18. The method of claim 17, wherein the first set of data items and the second set of data items comprise interrelated data.

19. The method of claim 18, wherein the interrelated data comprises at least one of time information and calendar information.

20. The method of claim 15, wherein the tracking of the detected two-finger gesture further comprises:
determining when the detected two-finger gesture represents a predetermined increment of rotation.
